(19) United States
(12) Patent Application Publication
(10) Pub. No.: US 2012/0197574 A1
(43) Pub. Date: Aug. 2, 2012

(54) Method For Calculating One Or More Parameters And A System For Detecting Spatial Placement

(75) Inventor: Dániel Rátai, Budapest (HU)

(73) Assignee: LEONAR3DO INTERNATIONAL ZRT., Etyek (HU)

(21) Appl. No.: 13/499,444

(22) PCT Filed: Jul. 31, 2009
(86) PCT No.: PCT/HU2009/000068

§ 371 Date: Mar. 30, 2012

(30) Foreign Application Priority Data
Aug. 1, 2008 (HU) P 0800490

(51) Int. Cl. G06F 19/00

(52) U.S. Cl. 702/94; 702/150

(57) ABSTRACT

According to a first aspect, the invention relates to a method for determining the value of one or more parameter(s) in a computer system, particularly in a system detecting spatial placement, in the course of which characteristic data relating to a particular situation belonging to a particular value-set of the one or more parameter(s) is entered into the computer system, and by means of the computer system virtual characteristic data is calculated from the virtual value-set belonging to a virtual situation of the one or more parameter(s), the deviation between the characteristic data relating to the particular situation and the virtual characteristic data is minimized by means of tuning of the value of the one or more parameter(s), wherein for each parameter, the parameter-value at the reached minimum is determined as the value of the parameter. According to a second aspect, the relates to a system utilizing the method.

### TECHNICAL FIELD

The present invention relates to a method for determining the value(s) of one or more parameter(s), and to a system, especially for detecting spatial placement, utilizing such method.

### BACKGROUND ART

There is a frequent need in the technical field for determining one or more parameters of a complex system. Such parameters to be determined, by way of example, may be present in connection with spatial systems, and relate to spatial placement, position, orientation. Exemplary applications may involve spatial placement detecting systems, as well as spatial optimization, preferably molecule optimization systems.

According to the prior art, several solutions are used for the determination of spatial placement, arrangement of a specific object or signal (source) (in the invention, spatial placement means the spatial position and/or orientation). Determination and tracking of spatial position is an extremely important task in several fields (e.g. virtual reality devices, motion capture, robotics, manufacturing technology). Such position determining devices function on the basis of gyroscopic, electromagnetic, ultrasound or optical principles. Gyroscopic devices measure their own relative rotation along three spatial axes, and are only capable of measuring real spatial positions when interconnected with other devices.

Electromagnetic position determination devices comprise a signal source (transmitter), one or more sensors and a computer control unit. The transmitter generates an electromagnetic field around itself, which is then sensed by the sensor(s) and the control unit calculates the sensed signals into spatial coordinates.

Ultrasound position determination devices also comprise a signal source (transmitter), one or more sensors (receiver) and a computer control unit. The transmitter is equipped with several loudspeakers emitting ultrasound, while the receiver(s) comprise several microphones sensing this ultrasound and transmitting it to the control unit. Owing to the speed of sound, the individual microphones sense the sounds of the specific loudspeakers in different ways, and the control unit calculates the position of the receivers thereof.

Also, optical position determination devices generally comprise a signal source (transmitter), a sensor (receiver) and a computer control unit, as well. The receivers are generally LEDs, lasers or light-reflecting elements, while the receivers are cameras, line sensors or photodiode/phototransistor arrangements. The photodiode/phototransistor arrangements are highly sensitive to the light reflection of the surrounding objects, therefore are extremely unreliable. All other known optical solutions are also relatively sensitive to the surrounding lights as well as to lights glittering from various surfaces. The trackable points, such as images of light sources, are detected on the images of the camera used in the camera position determination devices, and the spatial position thereof is calculated by means of the camera signals.

The area where no light source is presented at a specific time on the image of the cameras is not used. Taking a 320×240 pixel image size as an example, where a 10 pixel diameter light source is being tracked, the useful area is only approx. 0.1%, and this number decreases squarely when reducing the diameter of the light source or increasing the resolution of the camera. The use of cameras is moreover less advantageous because it requires a complex and expensive image processing unit in order to process the great amounts of data, and the sensor itself is also complex because it has to comprise great amounts of pixels and transmit them at high speed to the image processing unit. The cameras are furthermore noise-sensitive, as an image processing algorithm is required to separate the light source to be detected from the background, or, in case of several light sources, the light sources from one another.

In case line sensors, i.e. sensors comprising light sensors arranged one dimensionally, are used, the data processing unit is required to process significantly less data, therefore it requires less memory and computing capacity. Line sensors are generally manufactured in the form of IC. Line sensors have higher speed than cameras, essentially due to the less number of pixel to be processed. In case of cameras, determination of the spatial position of one point requires the use of at least two cameras. From the image of one camera, the possible position of a light source is reduced to one line, and the position of the light source is determined by the intersection of the two lines given by two images. The line sensors reduce the possible positions of the light source to one plane, therefore, at least three of them are generally required for detecting the spatial position of a light source (two planes intersect each other in one line, while three planes intersect one another in one point). The number of light sources and sensors is determined in view of the specific application, by way of example in case of a one-dimensional position determination, e.g. one signal source and one sensor may suffice.

In order to make the position determination systems susceptible of accurate detection of spatial placement, the algorithm stored in the computer device, which is part of the system, is required to know the physical and geometric parameters of the system. These parameters relate to the optical-spatial placement, possible distortion, and sensing/signal transmitting characteristics (e.g. exact position of light sources on a detected object) of the sensors and signal sources. It is a disadvantage of the known solutions, that extremely precise, complex and therefore costly manufacturing process can only provide the required parameter values in the course of manufacturing, in such a way that they will not change later. In solutions according to the prior art, therefore, sensors are assembled into one rigid system. This renders the entire system inflexible and reduces the fields of application. By way of example, such systems are disclosed in patent documents U.S. Pat. No. 4,193,689, U.S. Pat. No. 4,209,254 and U.S. Pat. No. 4,973,156.

Furthermore, another disadvantage of the known systems is that the equations serving for accurate determination of the spatial placement belonging to the predetermined fixed parameters will give inaccurate results in case of any change of the parameters and the calculation is unable to adapt to a modified state.

### DISCLOSURE OF INVENTION

It is an object of the invention to provide parameter-determining methods and systems, preferably in connection with spatial applications, which are able to eliminate the disadvantages and deficiencies of the prior art. One object of the invention is to provide a method for determining the values of one or more parameters, which enables accurate parameter determination, in case of any arbitrary internal and external parameters of the system elements. A further object of the invention is to provide a method, especially for the determination of spatial placement, which does not require to define previously the exact equations or relationships, but it “finds” the accurate parameter values similarly to system calibration. Yet another object of the present invention is to provide a system utilizing the above methods.

The objects according to the present invention can be achieved by means of the method according to claim 1, as well as by means of the systems according to claims 19 and 23. Preferred embodiments of the invention are defined in the dependent claims.

### BRIEF DESCRIPTION OF DRAWINGS

The preferred embodiments of the invention will now be described by way of example with reference to drawings, in which

FIG. 1 is a schematic view of a system for determining spatial placement according to the invention,

FIG. 2 is a schematic view of an optical sensor used in the system according to FIG. 1

FIG. 3 is a schematic view of an alternate embodiment of the optical sensor, and

FIG. 4 is a diagram of sensing by means of the optical sensors according to FIG. 2 or 3.

### MODES FOR CARRYING OUT THE INVENTION

The invention will be described below in connection with a position determination system, however, it is also applicable to all such other cases, where determination of one or more parameters, a determination of their value-set corresponding to the reality or to an optimum, is required.

The position determination system according to the invention does not require all geometric/signal transmitting/sensing parameters to be fixed previously and exactly, but one or more of those can be calibrated to the actual state. These parameters preferably comprise the parameters relative to spatial placement, i.e. position/orientation of the sensors (external parameters of the sensors), the sensing parameters of the sensors relative to, e.g. distortion, inner size (inner parameters of the sensors), parameters relating to the spatial placement of the positioning device comprising a signal source or signal sources (external parameters of the device), and/or parameters relating to the structure and signal transmission of the positioning device (inner parameters of the device). The exemplary preferred embodiments of the invention will be described below with regard to optical position determination, where the signal sources are light sources, preferably LEDs, and the sensors are optical sensors. It is to be understood, however, that the present invention is not only applicable for the purposes of optical position determination, but also for position determination based on other principles making use of signal sources and sensors.

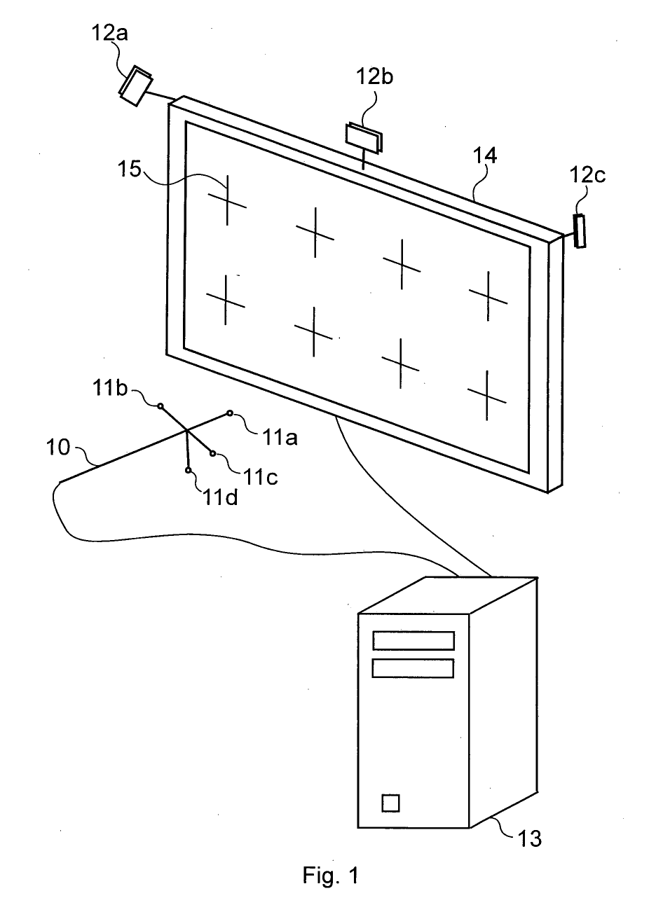

The system shown in FIG. 1 comprises a positioning device 10 equipped with signal sources. The positioning device 10 is used in the course of calibration as a calibrating device 10. The device 10 used for the calibration may be identical to the device capable of e.g. spatial manipulation, which is positioned during the actual operation and the position determination of which is being performed, or can be different thereof. In the description hereunder, the same device 10 is used for the calibration and the positioning as well. In the exemplary preferred embodiment, the calibrating device 10 is equipped with four signal sources 11a-d formed as LEDs. The LEDs are preferably operated in succession in a previously set order in a way that only one of the light sources is turned on at a time. The contrary is also conceivable, where all LEDs are turned on and only one is turned off at a time. In this way, all signal sources can be identified in the system. The use of LEDs is preferred for reasons of low energy demand, low cost, and due to its practical operation, i.e. it can be operated in impulse-controlled mode, which means that it can be flashed by short-time power impulses of higher than the nominal value. High-intensity, short-time flashes can be well detected, and this solution perfectly fits the alternating operation.

Certain light sources may flash up more frequently, if longer time-resolution is required for them. In extreme cases, several, e.g. two light sources may be turned on simultaneously, if, for example due to their distant spatial placement, they can be separated in the sensing signal of the sensor. In a given case, the LEDs do not necessarily have to flash in a pre-defined, fixed order, but the order may flexibly be set in the function of given circumstances.

Due to the flashes being effected in succession, the signals of the light sources are detected at different times, during which time-intervals the light sources may move. These movements may cause “shocks” during the position determination, which can be eliminated by compensation using the speed calculated from previous position sensings.

The represented system comprises three sensors 12a-c for sensing the signals coming from the signal sources 11a-d of the calibrating device 10. In the exemplary embodiment, each sensor 12a-c comprises an optical line sensor, which will be detailed later.

The calibrating device 10 equipped with signal sources 11a-d, as well as the sensors 12a-c are connected, via cables, in the illustrated exemplary embodiment, with a computer device 13. Obviously, the system according to the invention may be arranged in a wireless form. In a wireless case, the sensors may be used for e.g. synchronization or for information detection in command output. The computer device 13 executes the calculation part of the calibration and/or determination of the spatial placement according to the invention. The computer device according to the present invention does not only mean a computer, but also all other special electronics that include the calculating capacity required for the task.

The computer device according to the invention may be partitioned into several parts as well, and by way of example the sensors may be equipped with microprocessor units for digitally generating the sensed coordinate-data from the measurement signals, thereby serving to relieve a central unit which performs all other calculations.

In the course of the determination i.e. preferably the calibration or the position determination of the parameter-values according to the invention, the positioning device 10 is positioned into a selected spatial position (position/orientation), and in the selected position the signals coming from the signal sources 11a-d mounted to the calibrating device 10 are sensed by means of the sensors 12a-c. For the calibration, several input measurement data can be given by positioning the calibration device 10 into more than one selected spatial location, and calibration then is performed on the basis of more measurement values generated in such a way. More than one measurement value can be produced not only by moving the calibration device, but also by moving any elements in the system. It shall be taken into consideration, however, that by moving anything in the system, separate (e.g. external) parameters should be calculated in respect thereof. In this way, the calibration can be made more accurate, and, depending on the actual case, faster. In the individual calibration positions, measurement can be preferably started by a push-button (not illustrated) mounted on the positioning device 10. The push-button is not necessarily required to be mounted on the positioning device 10, and taking of a new calibration position cannot only be signalled with a push-button, but in any other way. An embodiment is also possible, where no separate signal is necessary for taking the calibration position, by way of example, in case the calibration and position tracking processes are united, the calibration can be performed by the computer device 13, automatically.

As a starting point for the calibration, the virtual measurement values of sensors 12a-c are determined for a virtual situation (situation=system status relevant to a given parameter value-set) relevant to a predetermined initial value-set of one or more parameters to be calibrated, i.e. the internal or external one or more parameters of the sensors 12a-c and/or the internal or external one or more parameters of the positioning device 10. Measurement values preferably mean the measured coordinate-data given by the signals of the sensors. Practically this means, that all unknown parameters (to be calibrated), e.g. the posₓ, pos_{y}, pos_{z} values of the spatial positions of the sensors 12a-c are set for an initial value, e.g. 0, moreover, the rotₓ, rot_{y}, rot_{z} values of the orientation thereof is also set for an initial value, e.g. 0 (and the same applies to all other unknown parameters), then for this virtual situation, on the basis of the descriptive spatial equations, virtual measurement values are calculated, i.e. virtual coordinate data, that would be measured by the sensors 12a-c. Obviously, it is also conceivable, that the approximate value of the given parameter is known, in which case it is expedient to enter this approximate value as the initial value. In the exemplary embodiment shown, the determination of the virtual measurement values means that on the basis of geometric equations given by the defined parameters it is calculated where the light points of the LEDs should fall on the sensors.

Thus, in the course of the measurement, the characteristic (one or more) data concerning a particular situation belonging to a particular value-set of one or more parameters is entered into the computer system.

As the next step, the deviations between the actual measurement values coming from the sensing (i.e. the characteristic data connected to the particular situation) and the virtual measurement values (the virtual characteristic data) are minimized by tuning the one or more parameter(s) to be calibrated. The minimization is preferably performed by finding an extreme-value of a pre-defined function (also called a stress-function), the input of which function is preferably constituted by the actual measurement values and the values of the parameters of the virtual situation. The output of the function is the stress value, which is preferably constituted of the differences between the individual actual measurement values and the virtual measurement values calculated on the basis of the values of the parameters of the virtual situation. The tests have proven that it is especially advantageous, if the sum of the squares of the deviations (stress value) is constituted, and the minimum thereof is searched in the course of the minimization (stress optimization).

An embodiment is also possible, where the parameters are optimal, if the maximum, and not the minimum, of the stress function is searched, or such optimal stress value is searched, which could be minus infinity, zero, plus infinity, or a particular number as well. For the sake of simplicity, we will only refer to minimum search hereunder.

According to the invention, for each individual parameter, the value of the given parameter at the minimum will be determined as the calibrated value. Therefore, there is no need for the individual calculation of the parameters, because it is sufficient to store the actual parameter-values as calibrated values at the global minimum reached by tuning.

Tuning of the parameters can be achieved in various different ways according to the invention. According to the invention, orientational stress optimalization means, that
the orientation of minimization is determined in respect of all parameters, which operation comprises the determination of the change (increase or decrease) direction being effective in the minimization direction, as well as the determination of the degree of increase or decrease (the value of the derivative of a function in a given point, along a given variable),
a global orientation of minimization is determined as the (net) resultant of the determined orientations of minimization, and
by stepping in the direction of the global orientation of minimization by a predetermined step size, the value of the function (stress value) is determined.

As it can be clearly seen from the above, the orientational stress optimization essentially means the optimization in a space having the dimension corresponding to the number of parameters. The stepping in the direction of global orientation of minimization takes place in this space, which, in respect of a given parameter means an alteration equivalent to the given “projection” of the step. By means of the step in the direction of the global orientation of minimization, therefore, the values of the given parameter alter accordingly and a new virtual situation arises. These new parameter-values constitute the predetermined initial value-sets in the next cycle, based on which the virtual measurement values can again be calculated by means of spatial equations, and the new stress value can be calculated on the basis of the differences between the virtual and actual measurement values.

As for the individual parameters, the orientation of minimization can be determined preferably by taking a small step with the value of the parameter and calculating the change (orientation, degree of change) of the stress function.

If we can derive our n-dimensional stress function, then another expedient procedure is that in which the n-dimensional derived function of the n-dimensional stress function is calculated. In this case, the degree of “slope” in a given position can be calculated directly.

It is also feasible, that during the minimum search, a further derivative or number n-derivative of the “slope” belonging to the individual parameters is determined, based on which extreme-value search can be made more effective and accelerated.

Stepping is preferably started with an initial step size and in the course of optimization the step size is preferably changed dynamically in a way that
in case of a stress value increase, i.e. in case of moving away from the extreme value, the step size is decreased, preferably by dividing it by S_{M}+D, and
in case of a stress value decrease, i.e. in case of approaching the extreme value, the step size is increased, preferably by multiplying it by S_{M}, where e.g. 1<S_{M}<2 and |D|<<S_{M}. For the value of S_{M} a value of approximately 1.2, and for the value D e.g. a value of approx. 0.01 may be chosen. D has a role of keeping such deviation between the degree of decrease and increase, that would eliminate any possible oscillations.

Preferably, the above operations are repeated as long as the step size decreases below a predetermined value.

According to the invention, stress optimization without orientation means that in the course of tuning the individual parameters are stepped separately by performing the undermentioned operations:
altering the parameter by a predetermined step,
examining whether the value of the function has moved in the direction of the searched extreme value through the alteration, and
determining on the basis of the examination result the step of the next alteration of the parameter. When determining the following step, if the function value moves into the direction of the searched extreme value, we leave the direction of the parameter step unaltered and increase the absolute value thereof, preferably multiplying it by S_{M1}, and in case the function value moves away from the searched extreme value, we reverse the direction of the parameter step and decrease its absolute value, preferably dividing it by S_{M2}, where 1<S_{M1}<2 and 1<S_{M2}. S_{M1} has a value of for example 1.2, and S_{M2} has a value of for example 4.

Preferably, the above operations are repeated until the step size decreases below a predetermined value with respect to all parameters.

The above tuning can also be performed relative to a part of the parameters, e.g. always effected for the parameter having the highest absolute value step or for parameters with steps exceeding a given step size threshold.

In the course of stress optimization without orientation, tuning can be performed simultaneously with respect to all parameters, however, according to one preferred embodiment of the invention we can also create groups made up of the parameters for independent optimalization. The groups can also have different stress functions. By way of example, if particular calibration positions are known, and we wish to optimize the sensors only, we can create as many groups as many sensors we have, all of which will optimize themselves.

In a given case, at least one master group and at least one respective slave group can be created. In this case, (as master optimization) the tuning is performed in respect of the master group of the parameters. The parameters belonging to the slave group are optimized to a degree determined by all individual tuning operations of the master optimization (slave minimization).

All optimization without, orientation may comprise slave optimizations and thereby become master, independently of whether all of its parameters had been optimized in its cycle period, or only its parameter having the greatest step distance. Preferably, orientational stress optimization can be a master optimization only, if it does not require optimization of slave optimizations for determining the orientation. This is possible, if we can previously calculate and define the n-dimensional derivative of the N-dimensional stress function.

In the course of examination of slave optimization applied in case of stress optimization without orientation
at given values of the parameters of the master group minimization of the parameters of the at least one respective slave group (slave minimization) is performed, and
the shift of the function value is examined at the minimum reached in the course of slave minimization.

The application of master-slave optimization makes possible to separate the parameters, to be calibrated, to be determined, from each other on the basis of any characteristic feature, to create groups thereof. Group formation is advantageous because it is not necessary to calibrate all parameters to each other. Parameters of master optimization are preferably composed of parameters, the minor alteration of which will result in changes of great degree in the course of parameter determination. Such parameters are for example, the external and internal parameters of the sensors. Accordingly, the parameters of slave optimization are preferably the external parameters of the positioning device 10, which in case of a given sensor position can be determined in an easily converging manner.

In the course of master-slave optimization, an arbitrary number of master optimization parameter-group and an arbitrary number of slave optimization parameter-group can be created. When using more than one position of the positioning device 10, e.g. the six parameters (three positional and three orientational parameter) of each calibration position of the device 10 may constitute a separate slave group. In the same manner, a separate master group may be constituted of the five external and two internal parameters (three orientational parameters and the other two positional parameters without position indifferent from the point of view of sensing, as well as the two coordinates describing the position of the slit or cylinder lens used in the line sensor) relevant to the position of each 12a-c sensor.

So within one cycle of the master optimization slave optimization parameter-group is optimized separately. It is useful to continue this slave optimization only up to a certain limit, since its outcome essentially results in an intermediate, disposable work value. The step limit of the slave optimization is preferably e.g. ten times the actual step value of the master optimization.

One slave optimization may include further salve optimizations, i.e. optimization processes may be carried out not only parallel to each other but also embedded into each other. The master-slave optimization can be implemented preferably in such a way that the master optimization is a stress-optimization without orientation, while the slave optimization is a stress-optimization with or without orientation.

Therefore the essence of the stress-optimization algorithm, that it creates one or more functions, the input parameters of which are the values to be optimized and the output value being the stress value. The function should be set so as to give the lowest (or highest) stress value for the optimal input value. By continuous alteration of the input parameters and by surveillance of whether the stress value is increasing or decreasing, the minimum (or maximum) of the stress function and thereby the optimal value of the input parameters can be found.

In the illustrated case, the input parameter-values of the stress function are the external and internal parameter values of the sensors (posₓ, pos_{y}, rotₓ, rot_{y}, rot_{z}, focusₓ, focus_{y}, as well as the distortion parameters, if calculation of distortion is intended), as well as the six degrees of liberty (posₓ, pos_{y}, pos_{z}, rotₓ, rot_{y}, rot_{z}) of the object(s) to be detected at every appearance, and the positions of its (their) light sources in the coordinate system of the object to be detected. The stress value is essentially the sum of the squares of the distances between the projected and the measured positions of the light sources, nevertheless other “additions” may be added to the stress function depending on the actual situation.

As mentioned above, the parameter determination method according to the invention may be applied for the arbitrary partial-set of the parameters. An essential recognition of the invention lies in that the method therefore can advantageously be applied for the determination of spatial position of the positioning device 10 in an already calibrated system. Tuning is then performed for the parameters, i.e. the posₓ, pos_{y}, pos_{z} values of the position and the rotₓ, rot_{y}, rot_{z} values of the orientation of the spatial position of the positioning device 10.

In this method, the positioning device 10 is positioned in a selected position in the space, in which selected position the signals coming from the signal sources 11a-d mounted to the positioning device 10 are sensed by the 12a-c sensors. Then, the virtual measurement values of the sensors 12a-c are determined in respect of a virtual situation belonging to a predetermined initial value-set of the parameters regarding the spatial position of the positioning device 10. Here, the predetermined initial value-set is preferably made up of the parameter-values regarding the latter determined spatial position of the positioning device 10. In one preferred embodiment, optimization is not started from the previous state, but from the most likely position calculated for a given instant from the speed resulting from the two previous states of the object to be detected. More preferably, not only the speed, but also the acceleration resulting from previous three states can be taken into consideration for determination of the likely position.

After this, on an analogous manner with the above, the deviation between the actual measurement values of the sensing and the virtual measurement values is minimized by means of tuning of the one or more parameter(s), where the value of the given parameter at the minimum is determined as the calibrated value.

The above optimization procedures comprise part of the invention and are not limited to being applied in connection with position determination apparatuses only. Any use is also possible, where the global minimum (or maximum) of multivariable, multidimensional functions is to be searched. By way of example, such application is the molecule-optimization.

As can be seen in FIG. 1 the sensors 12a-c preferably are mounted to a reference device 14 for example onto a positioning table representing a global coordinate system. If, indeed, we do not intend to determine the spatial placement of the device 10 in the coordinate system of the sensors 12a-c, but in another coordinate system, e.g. that of the reference device 14, the two coordinate systems need to be referred to each other. This is preferably realized by means of calibrating points represented by positioning signals 15 on the reference device 14, to which touching one distinguished point of the device 10, e.g. light source 11a, the calibration and reference measurement can be taken by means of the push-button.

It can be seen, that if the light sources are positioned along a fixed geometry on the object to be detected and the position of the sensors are also fixed relative to one another, then by “showing” the object to be detected to the sensors once or many times (depending on the light source or the number of sensors), the external and internal parameters of the sensors, the exact position of the light sources on the object to be detected, as well as all parameters of the spatial placement of the object to be detected are unambiguously resulted from the obtained measurement values. In a given case, other parameters may also be determined, by way of example the distortion-distribution or focus of the sensors.

It is an advantage of the invention, that the calibration procedure can be performed automatically in the course of operation without requiring a separate calibration step, as the sensors see the various positions of the object to be detected during the operation. At the beginning of its use, therefore, the system can calibrate itself automatically, furthermore, it is capable to refresh continuously the calibration data on the basis of the newly acquired measurement data.

A further advantage of the invention is that it is capable of calibration, position determination even if one or more signal source(s) of the sensors or signal sources are covered. According to the present art solutions, the position determination is performed according to exact equation system, which will not give result if just like one input parameter is missing. If, however, sensor/light source pairs are defined in the algorithm, by which we mean that the given sensor sees the given light source, all sensor/light source pairs may be used for calibration, position determination, irrespective of whether the given light source is seen by all sensors, or if all light sources are seen by one specific sensor. The stress optimization according to the invention is based on this principle, so the optimization is carried out always with regard to the active sensor-light source pairs, therefore it is able to give results even in case of covering(s).

In case of coverings, the partial signals of the light sources emerging from such coverings may hinder, detune the parameter determination process. Therefore, it would be expedient to consider the signal of appearing light sources, i.e. light sources emerging from covering, with increasing weight in terms of time or displacement, initially considering it by a value of e.g. 0 and in case of exceeding a threshold time or displacement, weight of the signal could be increased.

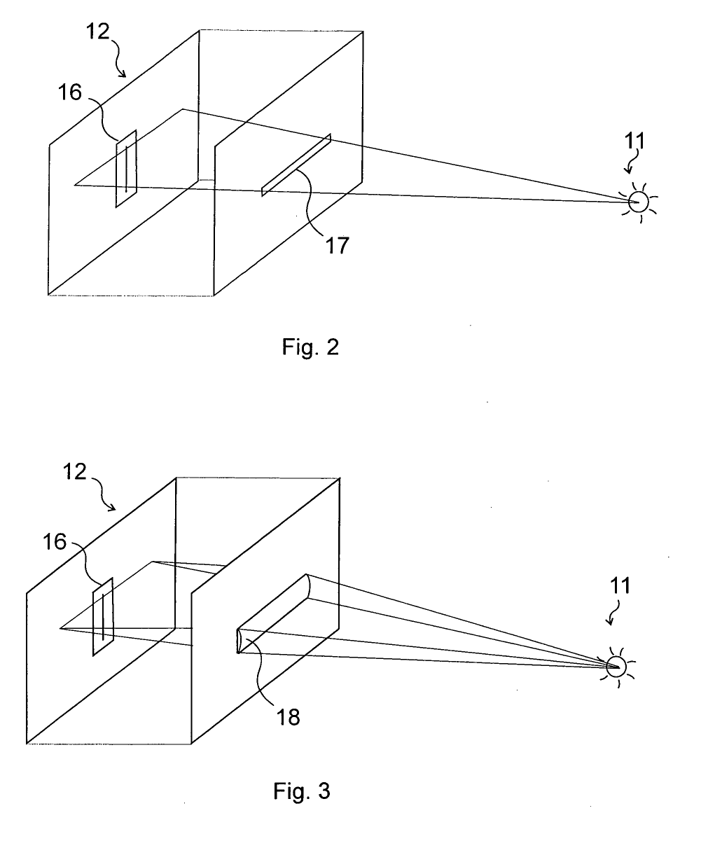

As seen in FIGS. 2 and 3, the signal source 11 is a light source, preferably a LED, the sensor 12 is an optical sensor comprising a line sensor 15 and a slit 16 or a cylindrical lens 17 arranged preferably perpendicular to the sensing line of the line sensor 15 at a distance from the line sensor 15. The sensor 12 limits the possible positions of the signal source 11 onto a (planar or curved) surface. In a given case, the slit 16 or the cylindrical lens may not only be positioned perpendicularly to the sensing line, but also by closing an angle therewith, for example due to manufacturing inaccuracies. The method according to the invention can be used for calibration and position determination successfully even in case of such value of the sensor's internal parameter.

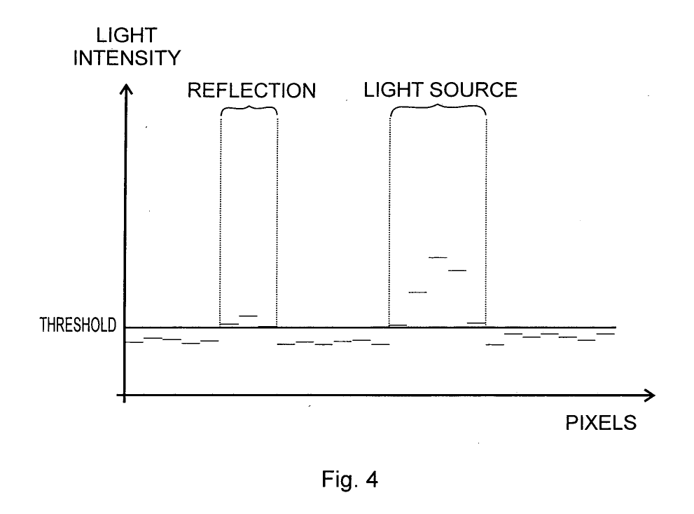

Because of the greater speed by a magnitude of the line sensors 15, if more light sources are to be detected, it is possible to flash them in succession, so they can securely be separated from each other or identified. The system can be made insensitive to surrounding as well as to glittering lights, since on account of the much greater speed there is the opportunity to shut down all light sources once per every period, and to measure the background light for every single pixel of the sensors. The glittering created by the light source (e.g. light reflected from a surface) may be filtered, as seen in FIG. 4, in a way that the are having above-threshold lightness of the lightest pixel is being averaged, namely because reflecting lights are always darker than the original. In case the sensing curves created by the light source and the reflecting light abut, analysis of the illumination power curve given by the sensor may be necessary.

By means of sensors 12 equipped with line-sensors more accurate, faster, and more reliable system can be developed than by means of camera-applied solutions, the production cost of which is furthermore a fraction of that of the camera-applied solutions.

The number of applied sensors and signal sources as well as the number of calibration positions used for calibration may be adapted to the actual circumstances. For the determination of the overall spatial placement (position/orientation) as well as for the entire calibration, in case of sensors 12 equipped with line sensor, the minimum numbers of Table 1 arise.

TABLE 1
Calibration
(minimum number)

| | | Calibr. |
|---|---|---|
| Sensor | Light source | position |
| 2 | 3 | 2 |
| 3 | 2 | 2 |
| 3 | 3 | 1 |
| 3 | 4 | 1 |
| 4 | 1 | 3 |

Determination of position
(minimum number)

| Sensor | Light source |
|---|---|
| 2 | 4 |
| 3 | 3 |
| 4 | 3 |

At least as many light sources and sensors are essentially needed which provide only one possible optimal value for the unknown parameter intended to be detected/searched. The system according to the invention therefore comprises a computer device determining the parameters of the sensor and/or the parameters of the calibration device based on at least one appearance of the calibration device (calibration position).

The high requirements, i.e. low price, high reliability, high accuracy, high spatial resolution in position determination, simple installation, high position-refreshing frequency, low reaction time set for the systems serving for determination of spatial placement can be met by means of the system and methods according to the invention. Flexible construction of the system arbitrary arrangement of the sensors and signal sources offer opportunities for new fields of application.

Possible variance or drift of the sensing parameters of the individual sensors does not impair the operation of the system, because the calibration effectively addresses these anomalies and accurate position determination can be provided by means of periodic or continuous calibration.

Of course, the present invention is not limited to the exemplary preferred embodiments as illustrated in the Figs., but further modifications are possible without leaving the scope of the invention defined in the claims. The methods and system according to the present invention may be applied not only in relation to systems based on optical principle, but, by way of example, also with regard to systems based on any other implementable principle. Nevertheless, the system according to the present invention may be calibrated not only by means of stress optimization, but also by means of one or more exact equation (s) characteristic of the system.

The invention makes possible the detection of an arbitrary number of positioning devices. A situation may be conceivable, in which all sensors and all positioning devices are in continuous movement (e.g. devices comprising signal sources and sensors are mounted onto moving objects) and in the course of position determination their positions relative to each other are determined (and/or to a global coordinate system). As reference devices determining the global coordinate system, static objects (e.g. reference table, monitor) as well as moving objects (e.g. conveyor belt, motor vehicle, robot arm) can be applied.

According to the invention, signal source shall have the widest possible meaning, and shall not be limited to a light source only, but also should comprise any other detectable signal source, e.g. optically detectable signal, light spot, mirrored light spot. By means of detecting a laser light spot as a signal source, the invention can establish self-calibrating spatial scanner with line sensor or camera sensing.

Position determination can be executed not only in 3D space, but in two or one-dimensional spaces as well, therefore the invention can also be applied for the purposes of linear shift and touch-screen detection. Other optimization methods differing from the one described in detail can also be applied.

The present invention can be applied in every field, where the determination of system parameter(s) is required. System parameters can be determined not only for an implementable particular system situation, but also for an ideal situation, e.g. an optimal situation corresponding to an energy minimum. Such would be the case for e.g. finding the energy minimum of spatial systems, preferably in case of molecules. In this case, the parameters to be determined are the spatial parameters of the position of the individual molecule-parts, in respect of which the optimal parameter value-set is searched by stress function-optimization relative to the energy minimum.

1. A method for determining value(s) of one or more parameter(s) in a computer system, the method comprising the step of
entering, into the computer system, characteristic data relating to a particular situation belonging to a particular value-set of the one or more parameter(s),
characterized in that, by means of the computer system,
calculating virtual characteristic data from a virtual value-set belonging to a virtual situation of the one or more parameter(s),
minimizing the deviation between the characteristic data relating to the particular situation and the virtual characteristic data by means of tuning of the value(s) of the one or more parameter(s), wherein
for each parameter, the parameter-value at the reached minimum is determined as the value of the parameter.

2. The method according to claim 1, characterized in that the minimization comprises the search of a given value, preferably an extreme-value, of a predetermined function, for the formulation of the output of which the deviation between the characteristic data relating to a particular situation and the virtual characteristic data is used.

3. The method according claim 2, characterized in that the tuning of the parameters is performed by:
determining minimization orientations for all parameters, which step comprises the determination of the alteration direction (increase or decrease) towards minimization, as well as the determination of the degree of increase or decrease (the value of the derivative of the function in a given point, along the given variable);
determining a global orientation of minimization as the overall (resultant) of the determined minimization orientations, and
stepping in the direction of the global orientation of minimization by a predetermined step size, and determining the value of the function.

4. The method according to claim 3, characterized in that in the course of stepping, the step size is dynamically altered in a way that
in case of going away from the extreme value, the step size is decreased,
in case of approaching the extreme value, the step size is increased.

5. The method according to claim 2, characterized in that in the course of tuning, the parameters are stepped independently, by performing the following steps:
altering the parameter by a pre-defined step,
examining whether the value of the function has moved in the direction of the searched extreme value through the alteration, and
on the basis of the result of the examination, determining the next step of alteration of the parameter.

6. The method according to claim 5, characterized in that the tuning is performed to every parameter.

7. The method according to claim 5, characterized in that the tuning is always performed for the parameter having the step of the highest absolute value.

8. The method according to claim 5, characterized in that groups are formed from the parameters, and minimization is performed independently for the groups, in a given case by applying different functions for the groups.

9. The method according to claim 5, characterized in that at least one master group and at least one respective slave group is formed from the parameters, and the tuning is performed only with regard to the parameters of the master group, and during the examination
at given values of the parameters of the master group, minimization is performed for the parameters of the at least one respective slave group (slave minimization) and
the move of the function value is examined at the minimum reached during the slave minimization.

10. The method according to claim 5, characterized in that
if the function value moves into the direction of the searched extreme value, the direction of the parameter step remains unaltered and the absolute value thereof is increased, and
if the function value moves away from the searched extreme value, the direction of the parameter step is reversed and its absolute value is decreased.

11. The method according to claim 2, characterized in that the sum of the squares of the deviations is formed as a function, and in the course of the minimization the minimum thereof is searched.

12. The method according to claim 1, characterized in that it is used for determining the value(s) of one or more parameter(s) in a system detecting spatial placement, the system comprising:
at least one signal source (11, 11a, 11b, 11c, 11d),
at least one sensor (12, 12a, 12b, 12c) for detecting a signal coming from the at least one signal source (11, 11a, 11b, 11c, 11d), and a computer device (13) determining the spatial placement of the at least one signal source (11, 11a, 11b, 11c, 11d) on the basis of the measurement value of the at least one sensor (12, 12a, 12b, 12c),
wherein the method comprises the steps of
detecting, at a given moment, by means of the at least one sensor (12, 12a, 12b, 12c) the signal from the at least one signal source (11, 11a, 11b, 11c, 11d), wherein the characteristic data relevant to the particular situation is the value so measured,
determining, for the virtual situation belonging to a pre-defined initial value-set of the one or more parameter(s), the virtual measurement value of the at least one sensor (12, 12a, 12b, 12c) is, and
the deviation between the actual measurement value of the sensing and the virtual measurement value is minimized by means of tuning the one or more parameter(s).

13. The method according to claim 12, characterized in that it is used for calibrating the system, and the one or more parameter(s) comprise:
one or more parameter(s) relating to the spatial placement of the sensor (12, 12a, 12b, 12c), and/or
one or more parameter(s) relating to the sensing characteristics of the sensor (12, 12a, 12b, 12c), and/or
one or more parameter(s) relating to the spatial placement of the at least one signal source (11, 11a, 11b, 11c, 11d).

14. The method according to claim 12, characterized in that it is used for the detection of spatial placement, and the one or more parameter(s) comprise:
one or more parameter(s) relating to the spatial placement of the at least one signal source (11, 11a, 11b, 11c, 11d).

15. The method according to claim 13, characterized in that a number of signal sources (11, 11a, 11b, 11c, 11d) are used, which are mounted to a positioning device (10), and the spatial placement of the positioning device (10) is detected by means of the computer device (13).

16. The method according to claim 15, characterized in that the one or more parameter(s) comprise:
one or more parameter(s) relating to the spatial placement of the positioning device (10) and/or
one or more parameter(s) relating to the structure of the positioning device (10).

17. The method according to claim 14, characterized in that, the pre-defined initial value-set is composed of the one or more parameter-value(s) calculated on the basis of the last determined spatial placement(s) of the at least one signal source (11, 11a, 11b, 11c, 11d).

18. The method according to claim 12, characterized in that the signal from the at least one signal source (11, 11a, 11b, 11c, 11d) is sensed by means of the at least one sensor (12, 12a, 12b, 12c) at more than one times, in different positions, and the measurement values of the different positions are used for the minimization.

19. A system for detecting spatial placement, comprising:
a positioning device (10) having at least one signal source,
at least one sensor (12, 12a, 12b, 12c) for detecting a signal from the at least one signal source (11, 11a, 11b, 11c, 11d) of the positioning device (10), and
a computer device (13) for determining the spatial placement of the positioning device (10) based on the measurement value of the at least one sensor (12, 12a, 12b, 12c),
characterized by comprising a computer device (13) performing the method according to claim 1.

20. The system according to claim 19, characterized by comprising optical sensors (12, 12a, 12b, 12c), each of the optical sensors (12, 12a, 12b, 12c) comprising a line sensor (15) and a slit (16) or cylindrical lens (17) arranged preferably perpendicular to a sensing line of the line sensor (15) at a distance from the line sensor (15).

21. The system according to claim 20, characterized in that the positioning device (10) comprises more than one light source, which are being operated in a predetermined, or flexibly defined order in such a way, that only one of the light sources is turned on or off at a time.

22. The system according to claim 21, characterized in that it also has a state for background light measurement in which all light sources are turned off.

23. A system for detecting spatial placement, comprising
a calibration device having at least one signal source, and
at least one sensor (12, 12a, 12b, 12c) having a line-sensor (15),
characterized in that the system further comprises a computer device for determining the parameters of the sensor (12, 12a, 12b, 12c) and/or the parameters of the calibration device on the basis of at least one appearance of the calibration device.

24. A system for detecting spatial placement, comprising
a calibration device having at least one signal source, and
at least one sensor (12, 12a, 12b, 12c) having a line-sensor (15),
characterized in that the system further comprises a computer device for determining the parameters of the sensor (12, 12a, 12b, 12c) and/or the parameters of the calibration device on the basis of at least one appearance of the calibration device, further characterized in that the computer device determines the parameters according to claim 1.

25. The system according to claim 23, characterized in that the at least one calibration device is a positioning device.
